(19) United States
(12) Patent Application Publication
(10) Pub. No.: US 2006/0114275 A1
(43) Pub. Date: Jun. 1, 2006

(54) Display apparatus and control method thereof

(76) Inventors: Young-chan Kim, Uiwang-si (KR); Jin-hun Kim, Seoul (KR)

Correspondence Address: STANZIONE & KIM, LLP, 919 18TH STREET, N.W., SUITE 440, WASHINGTON, DC, 20006, US

(21) Appl. No.: 11/288,314

(22) Filed: Nov. 29, 2005

(30) Foreign Application Priority Data
Dec. 1, 2004 (KR) 2004-100030

(51) Int. Cl. G09G 5/02

(52) U.S. Cl. 345/698

(57) ABSTRACT

A display apparatus comprises a display panel; a resolution adjustor adjusting a resolution of a video signal and outputting the adjusted video signal and a pixel clock signal; a frequency adjustor adjusting a frequency of the pixel clock signal outputted from the resolution adjustor; and a controller controlling the frequency adjustor to adjust the frequency of the pixel clock signal in a blank range so as to correspond the number of the pixel clock signal from the resolution adjustor for a frame to the predetermined number. Thus, the present invention provides a display apparatus and a control method thereof to control a frequency of a pixel clock signal in a blank range so as to correspond the number of the pixel clock signal and a horizontal synchronization signal to the predetermined number after controlling a resolution of a video signal from an external apparatus.

### CROSS-REFERENCE TO RELATED APPLICATIONS

This application claims the benefit of Korean Patent Application No. 2004-0100030, filed on Dec. 1, 2004, in the Korean Intellectual Property Office, which is hereby incorporated by reference for all purposes as if fully set forth herein.

### BACKGROUND OF THE INVENTION

1. Field of the Invention

The present invention relates to a display apparatus and a control method thereof, and more particularly, to a display apparatus and a control method thereof, wherein the number of a pixel clock signal corresponds to a predetermined number.

2. Description of the Related Art

Generally, a display apparatus receives a video signal of a predetermined display mode from a video signal source, such as a computer, a television broadcasting system, etc., thereby displaying a picture on a screen thereof. Recently cathode ray tubes (CRT) are being replaced with flat panel displays such as a liquid crystal display (LCD) panel, a plasma display panel (PDP), an organic electro luminescent display (OELD), etc.

A flat panel display apparatus receives an analog video signal from a video signal source and converts the analog video signal into a digital video signal, thereby displaying a picture. The flat panel display apparatus includes an analog/digital (A/D) converter to convert the analog video signal into the digital video signal. Further, the digital video signal is processed by a preset operation and transmitted to an LCD panel or the PDP, thereby driving a pixel corresponding to the digital video signal and displaying a picture.

The display mode of the video signal transmitted from the video signal source, such as a computer or the like, includes various resolutions, such as 640×480; 800×600; 1024×768; 1600×1200; 1920×1200, etc. For example, when the video signal having a resolution of 640×480 is transmitted from the video signal source to the display apparatus having the display mode based on a resolution of 1024×768, a scaler in the display apparatus may control the resolution of the video signal.

When a conventional display apparatus controls the resolution of the video signal through the scaler, the number of lines for one frame (V-total) of the controlled video signal may not be suitable for the output standard of the display apparatus.

When the V-total of the controlled video signal is larger than the predetermined V-total of an output signal, the scaler may control the V-total of the controlled video signal to adjust the output standard of the display panel. However, when this happens, the image may not be a full-screen image. Although the V-total of the controlled video signal is suitable for the output standard of the display panel, a short line problem, e.g., at least one line may be smaller than the predetermined length, may occur. When the short line problem occurs, the image may be distorted or shaken or white line may be displayed on the screen.

Specifically, when the video signal of 640×480 75 HZ received from an external apparatus is controlled to be 1280×1024 75 HZ, the video signal may be displayed with an error. For example, when the inputted video signal of 640×480 75 HZ has the V-total of 50 lines, the controlled video signal of 1280×1024 75 HZ will have the V-total of 1066.66 lines. Thus, the video signal must be output as 1067 lines, which may cause the video signal to be displayed with an error.

To solve the above described problem, the conventional apparatus may further include a frame rate converter (FRC) to control the number of lines; however, the FRC is not desirable because it is very expensive.

### SUMMARY OF THE INVENTION

Accordingly, it is an aspect of the present invention to provide a display apparatus and a control method thereof to control a frequency of a pixel clock signal in a blank range so as to correspond the number of the pixel clock signal and a horizontal synchronization signal to the predetermined number after controlling a resolution of a video signal from an external apparatus.

Additional features of the invention will be set forth in the description which follows, and in part will be apparent from the description, or may be learned by practice of the invention.

The invention discloses a display apparatus including a display panel, a resolution adjustor adjusting a resolution of a video signal and outputting the adjusted video signal and a pixel clock signal, a frequency adjustor adjusting a frequency of the pixel clock signal, and a controller controlling the frequency adjustor to adjust the frequency of the pixel clock signal in a blank range so that a number of periods of the pixel clock signal from the resolution adjustor for a frame corresponds with a predetermined number of pixel clock signal periods.

The invention further discloses a method of controlling a display apparatus having a display panel, including adjusting a resolution of a video signal, determining whether a number of periods of a pixel clock signal for the adjusted video signal is the same as a predetermined number of pixel clock signal periods, and adjusting a frequency of the pixel clock signal in a blanking range of the video signal so that the number of periods of the pixel clock signal corresponds with the predetermined number of pixel clock signal periods.

The invention further discloses a device receiving a video signal to supply a display panel with an output signal, including a resolution adjustor adjusting a resolution of the video signal and outputting the adjusted video signal and a pixel clock signal; a frequency adjustor adjusting a frequency of the pixel clock signal; and a controller controlling the frequency adjustor to adjust the frequency of the pixel clock signal in a blank range so that a number periods of the pixel clock signal from the resolution adjustor for a frame corresponds with a predetermined number of pixel clock periods.

The invention further discloses a method of controlling a device receiving a video signal to supply a display panel with an output signal, including: adjusting a resolution of the video signal; determining whether a number of periods of a pixel clock signal for the adjusted video signal is the same as a predetermined number of pixel clock signal periods; and adjusting a frequency of the pixel clock signal in a blanking range of the video signal so that the number of periods of the pixel clock signal correspond with the predetermined number of pixel clock signal periods.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control block diagram of a display apparatus according to an embodiment of the invention.

FIG. 2 is a waveform of a video signal and a pixel clock signal according to an embodiment of the invention.

FIG. 3 is a control flowchart of a display apparatus according to an embodiment of the invention.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

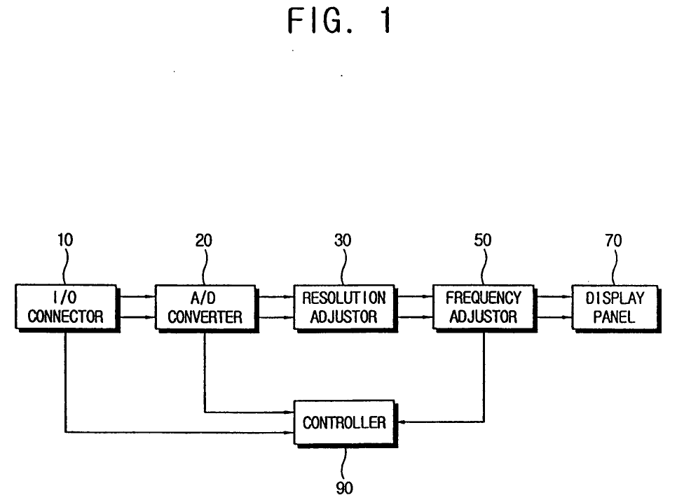

As shown in FIG. 1, a display apparatus according to an embodiment of the present invention comprises an I/O connector 10 input has an analog video signal from an external apparatus, an A/D converter 20 converting the analog video signal into a digital video signal, and a display panel 70 displaying an image according to the video signal. The display apparatus may further include a resolution adjustor 30 adjusting a resolution of the digital video signal, a frequency adjustor 50 adjusting a frequency of the video signal, which may be received from the resolution adjustor 30, and a controller 50.

The I/O connector 10 receives the analog video signal from a video signal source such as a computer, a television broadcasting system, or the like. The analog video signal includes analog video data, a horizontal synchronization signal, and a vertical synchronization signal.

The I/O connector 10 may include various types of connectors receiving the video signal of various formats. For example, the I/O connector 10 may include at least one of a D-sub connector, a composite video broadcast signal (CVBS) connector, an S-video connector, or a component connector, in order to receive the analog video signal.

The A/D converter 20 converts the analog video signal inputted through the I/O connector 10 into the digital video signal. The A/D converter 20 outputs a pixel clock signal and the horizontal synchronization signal of a set frequency, a data signal, and a data enable signal, which are standard signals for displaying an image on the display panel 70. The data enable signal may include information relating to the horizontal synchronization signal.

The display panel 70 may display the image on a screen according the digital video signal received from the resolution adjustor 30. The display panel 70 may be an LCD panel, a PDP, or the like, so long as the display panel is able to display the image based on the digital video signal.

The video signal input to the display panel 70 includes an active range and a blank range. Specifically, a value of the data enable signal may be set as 1 for the active range, e.g., when the image is displayed on the display panel 70. A value of the data enable signal may be set to 0 for the blank range e.g., when the image is not displayed on the display panel 70.

The resolution adjustor 30 receives the data enable signal, the pixel clock signal, the horizontal synchronization signal, and data signal from the A/D converter 20. When the video signal is not suitable for the output standard of the display panel 70, the resolution adjustor 30 adjusts the resolution of the video signal so that the pixel clock signal is adjusted. The video signal from the external apparatus may include various resolutions of 640×480; 720×400; 800×600; 1024×768; 1280×1024; 1400×1024; 1600×1200 and so on. When the video signal from the external apparatus has a resolution of 640×480, the resolution adjustor 30 may adjust the video signal to have the resolution of 1280×1024 so that the video signal is suitable for the output standard of the display panel 70.

The frequency adjustor 50 may receive the video signal, the pixel clock signal, etc. from the resolution adjustor 30. When the number of the pixel clock signal corresponding to a frame is not the same as a predetermined number, the frequency adjustor 50 adjusts the frequency of the pixel clock signal in the blank range of the video signal. The predetermined number of the pixel clock signal may be suitable for the output standard of the display panel 70.

The frequency adjustor 50 may reduce the frequency of the pixel clock signal in order to reduce the number of the pixel clock signal input to the blank range when the number of the pixel clock signal input thereto is greater than the predetermined number. For example, when the number of the pixel clock signal exceeds a standards or design capability of the display panel 70, the frequency adjustor 50 may reduce the frequency of the pixel clock signal. One period of the horizontal synchronization signal includes a preset number of the pixel clock signal, and forms a line. The V-total is the total number of lines output for a frame. Accordingly, when the number of the pixel clock signal exceeds the standards of the display panel 70, the V-total of the video signal also exceeds the specification of the display panel 70.

For example, when the display panel 70 displays the video signal having between 1220 and 1225 lines of V-total, the video signal from the resolution adjustor 30 may have a greater number of lines, such as 1250 lines. When this occurs, the 1200 lines of the video signal may be output in the active range and the remaining 50 lines are output in the blank range. When the frequency of 1 pixel clock signal is 100 MHz, the frequency adjustor 50 may adjust the frequency thereof to 50 MHz. As a result, 50 lines of video signal are output during the blank range in which 25 lines are output.

The frequency adjustor 50 may increase the frequency of the pixel clock signal when the number of the pixel clock signal is less than the predetermined number. For example, when the number of the pixel clock signal provided in the last line of the video signal exceeds the standards or design capability of the display panel 70, the frequency adjustor 50 may increase the frequency of the pixel clock signal. For example, the blank range may be generated for approximately 10 μsec. A period of the pixel clock signal may be 0.11 μsec, and a period of the horizontal synchronization signal may be 1.1 μsec. The 10 periods of the horizontal synchronization signal may be input in the blank range. Then, a conventional display apparatus, in which the frequency of the pixel clock signal is fixed, normally inputs 9 signals to the display panel 70, and the last signal inputted therefrom may be abnormally short. However, the display apparatus according to the present invention may include the frequency adjustor 50 to adjust the period of the pixel clock signal input in the blank range to, for example, 1 μsec. As a result, the 10 horizontal synchronization signals may be normally input in the blank range.

The controller 90 may determine whether the video signal input to the resolution adjustor 30 is suitable for the output standard of the display panel 70. When, the resolution of the video signal input to the resolution adjustor 30 is determined not to be suitable for the standards of the display panel 70, the controller 90 may control the resolution adjustor 30 to adjust the resolution of the video signal.

The controller 90 determines whether the short line problem occurs and/or the V-total exceeds the output standard of the display panel 70. The controller 90 determines for the respective frames whether the number and/or the length of the horizontal and vertical synchronization signals are the same as the predetermined number and/or the predetermined length. When the number and/or the length is not the same as the predetermined number and/or the predetermined length, the controller 90 calculates the frequency of the pixel clock signal so that it may be adjusted accordingly by the frequency adjustor 50.

The controller 90 also calculates the frequency of the horizontal synchronization signal when the horizontal synchronization signal is input to the frequency adjusting 50. However, the controller 90 may not calculate the frequency of the horizontal synchronization signal when the frequency of the horizontal synchronization signal is proportional to the frequency of the pixel clock signal.

The controller 90 controls the frequency adjustor 50 to adjust the frequency of the inputted pixel clock signal to the calculated frequency when it determines that the blank range of the video signal has begun. The controller 90 may control the frequency adjustor 50 to adjust the frequency of the input horizontal synchronization signal when the horizontal synchronization signal is separately inputted to the frequency adjustor 50. The controller 90 controls the frequency adjustor 50 to readjust the adjusted frequency of the pixel clock signal to the initial frequency before the blank range begins when the blank range of the video signal finishes.

When the controller 90 determines that the number and/or the length of the lines are the same as the predetermined number and/or the length, the controller 90 may control the video signal and/or the pixel clock signal output from the resolution adjustor 30 to bypass the frequency adjustor 50.

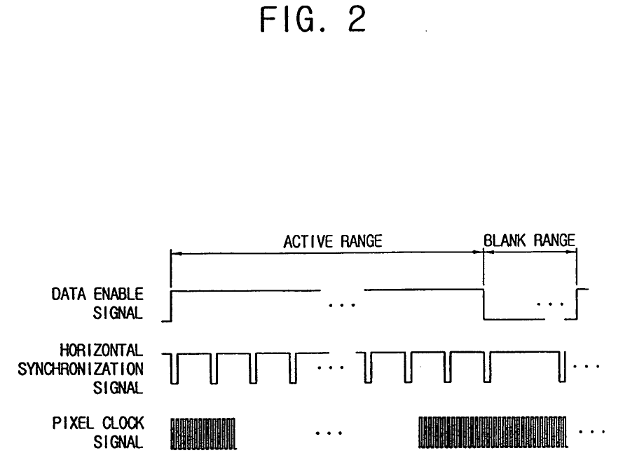

As shown in FIG. 2, the video signal includes the data enable signal and the horizontal synchronization signal. The one period of the data enable signal corresponds with the one frame displayed on the display panel 70, and the one period of the horizontal synchronization signal becomes the one line displayed on the display panel 70. The number of the lines, which is the number of periods of the horizontal synchronization signal, input thereto during the one period of the data enable signal is the V-total.

The controller 90 adjusts the frequencies of the horizontal synchronization signal and the pixel clock signal blank range begins. When a new frame is displayed on the display panel 70 after finishing the blank range, the frequencies of the pixel clock signal and the horizontal synchronization signal are readjusted to the initial frequency, which is the same as the frequency before the blank range begins.

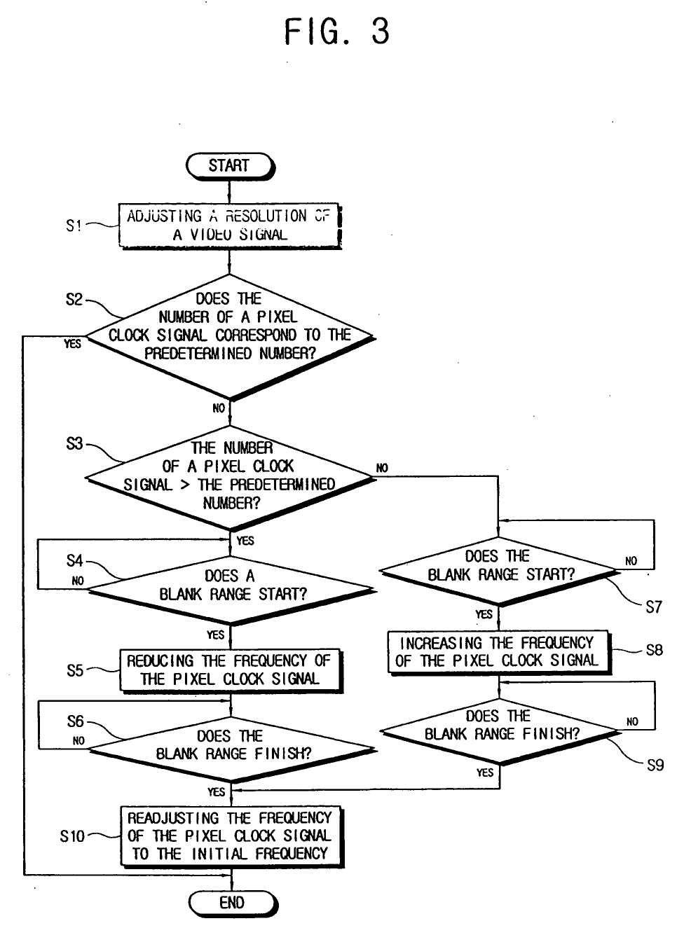

FIG. 3 is a control flowchart of a display apparatus according to an embodiment of the invention. The display apparatus includes inputting an analog video signal from the external apparatus through an I/O connector 10, and transmitting the analog video signal to an A/D converter 20. The A/D converter 20 converts the analog video signal to a digital video signal, and outputs a pixel clock signal of a predetermined period. The A/D converter 20 outputs a data enable signal, a horizontal synchronization signal, and the pixel clock signal to a resolution adjustor 30, which adjusts the resolution of the video signal, as shown in operation S1.

The controller 90 determines whether the V-total of the video signal output from the resolution adjustor 30 exceeds an output standard of the display panel 70 and whether a short-line problem occurs as shown in operation S2. In other words, the controller 90 determines whether the number of the pixel clock signal from the resolution adjustor 30 is the predetermined number.

The controller 90 determines whether the number of the pixel clock signal is greater than the predetermined number at operation S3. When the blank range of the video signal is detected to begin when the number of the pixel clock signal is greater than the predetermined number at operation S4, the frequency adjustor 50 reduces the frequency of the pixel clock signal at operation S5.

The frequency adjustor 50 may also reduce the frequency of the horizontal synchronization signal. It is then determined whether the blank range is finished at operation S6. When the blank range is finished, the frequency of the pixel clock signal is readjusted to the initial frequency before the blank range starts at operation S10. When it is detected that the blank range of the video signal starts at operation S7 when the case that the number of the pixel clock signal is smaller than the predetermined number at operation S3, the frequency adjustor 50 increases the frequency of the pixel clock signal at operation S8.

It is than determined whether the blank range is finished at operation S9. When the blank range is finished, the frequency of the pixel clock signal is readjusted to the initial frequency before the blank line starts at operation S10. When the number of the pixel clock signal from the resolution adjustor 30 is the same as the predetermined number, as determined in operation S2, the frequency of the pixel clock signal is not adjusted and the pixel clock signal is output to the display panel 70 after bypassing the frequency adjustor 50.

The frequency adjustor 50 and the resolution adjustor 30 according to the present invention may be provided in the display apparatus, and/or in an extra device. The controller 90 may be also provided in the extra device. If the device may receive the video signal and outputs the video signal to the display panel 70, the range of the device is not limited. The extra device may be provided internally in the display apparatus, or externally out of the display apparatus. Herein, the device may be a chip provided in the display apparatus.

As described above, the display apparatus according to the invention adjusts the resolution of the video signal from the external apparatus, and then adjusts the frequency of the pixel clock signal and the horizontal synchronization signal. Accordingly, the display apparatus is able to prevent the short-line problem or the image from not being displayed or generated on an entire display screen, which is not full screen from being generated.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A display apparatus comprising:
a display panel;
a resolution adjustor adjusting a resolution of a video signal and outputting the adjusted video signal and a pixel clock signal;
a frequency adjustor adjusting a frequency of the pixel clock signal; and
a controller controlling the frequency adjustor to adjust the frequency of the pixel clock signal in a blank range so that a number of periods of the pixel clock signal from the resolution adjustor for a frame corresponds with a predetermined number of pixel clock signal periods.

2. The display apparatus of claim 1, wherein the predetermined number is suitable for an output standard of the display panel.

3. The display apparatus of claim 2, wherein the frequency adjustor adjusts a frequency of a horizontal synchronization signal in proportion with the frequency of the pixel clock signal.

4. The display apparatus according to claim 2, wherein the frequency adjustor comprises a Phase Lock Loop.

5. The display apparatus of claim 2, wherein the controller controls the pixel clock signal to bypass the frequency adjustor when the number of periods of the pixel clock signal from the resolution adjustor is the same as the predetermined number of pixel clock signal periods.

6. The display apparatus of claim 1, wherein the frequency adjustor adjusts a frequency of a horizontal synchronization signal in proportion to the frequency of the pixel clock signal.

7. The display apparatus of claim 1, wherein the frequency adjustor comprises a Phase Lock Loop.

8. The display apparatus of claim 1, wherein the controller controls the pixel clock signal to bypass the frequency adjustor when the number of periods of the pixel clock signal from the resolution adjustor is the same as the predetermined number of pixel clock signal periods.

9. A method of controlling a display apparatus having a display panel, comprising:
adjusting a resolution of a video signal;
determining whether a number of periods of a pixel clock signal for the adjusted video signal is the same as a predetermined number of pixel clock signal periods; and
adjusting a frequency of the pixel clock signal in a blanking range of the video signal so that the number of periods of the pixel clock signal corresponds with the predetermined number of pixel clock signal periods.

10. The method of claim 9, wherein the predetermined number of pixel clock signal periods is suitable for an output standard of the display panel.

11. The method of claim 10, further comprising:
adjusting the frequency of the pixel clock signal so that the number of periods of the pixel clock signal corresponds with the predetermined number of pixel clock period signals when the blanking range starts; and
readjusting the frequency of the pixel clock signal to an initial frequency when the blanking range finishes.

12. The method of claim 11, further comprising:
bypassing the frequency adjustor without adjusting the frequency of the pixel clock signal when the number of periods of the pixel clock signal is the same as the predetermined number of pixel clock signal periods.

13. The method of claim 10, further comprising:
adjusting a frequency of a horizontal synchronization signal of the video signal in proportion with the frequency of the pixel clock signal.

14. The method of claim 9, further comprising:
adjusting the frequency of the pixel clock signal so that the number of periods of the pixel clock signal correspond with the predetermined number of pixel clock signal periods when the blanking range starts; and
readjusting the frequency of the pixel clock signal to an initial frequency when the blanking range finishes.

15. The method of claim 14, further comprising:
bypassing the frequency adjustor without adjusting the frequency of the pixel clock signal thereof when the number of periods of the pixel clock signal is the same as the predetermined number of pixel clock signal periods.

16. The method of claim 9, further comprising:
adjusting a frequency of a horizontal synchronization signal of the video signal in proportion with the frequency of the pixel clock signal.

17. A device receiving a video signal to supply a display panel with an output signal, comprising:
a resolution adjustor adjusting a resolution of the video signal and outputting the adjusted video signal and a pixel clock signal;
a frequency adjustor adjusting a frequency of the pixel clock signal; and
a controller controlling the frequency adjustor to adjust the frequency of the pixel clock signal in a blank range so that a number periods of the pixel clock signal from the resolution adjustor for a frame corresponds with a predetermined number of pixel clock periods.

18. The device of claim 17, wherein the predetermined number is suitable for the output standard of the display panel.

19. The device of claim 18, wherein the frequency adjustor adjusts a frequency of a horizontal synchronization signal in proportion with the frequency of the pixel clock signal.

20. The device of claim 18, wherein the frequency adjustor comprises a Phase Lock Loop.

21. The device of claim 18, wherein the controller controls the pixel clock signal to bypass the frequency adjustor when the number of periods of the pixel clock signal from the resolution adjustor is the same as the predetermined number of pixel clock signal periods.

22. The device of claim 17, wherein the frequency adjustor adjusts a frequency of a horizontal synchronization signal in proportion to the frequency of the pixel clock signal.

23. The device of claim 17, wherein the frequency adjustor comprises a Phase Lock Loop.

24. The device of claim 17, wherein the controller controls the pixel clock signal to bypass the frequency adjustor when the number of periods of the pixel clock signal from the resolution adjustor is the same as the predetermined number of pixel clock signal periods.

25. A method of controlling a device receiving a video signal to supply a display panel with an output signal, comprising:
adjusting a resolution of the video signal;
determining whether a number of periods of a pixel clock signal for the adjusted video signal is the same as a predetermined number of pixel clock signal periods; and
adjusting a frequency of the pixel clock signal in a blanking range of the video signal so that the number of periods of the pixel clock signal correspond with the predetermined number of pixel clock signal periods.

26. The method of claim 25, wherein the predetermined number of pixel clock signal periods is suitable for an output standard of the display panel.

27. The method of claim 26, further comprising:
adjusting the frequency of the pixel clock signal so that the number of periods of the pixel clock signal correspond with the predetermined number of pixel clock period signals when the blanking range starts; and
readjusting the frequency of the pixel clock signal to the initial frequency when the blanking range finishes.

28. The method of claim 27, further comprising:
bypassing the frequency adjustor without adjusting the frequency of the pixel clock signal when the number of periods of the pixel clock signal is the same as the predetermined number of pixel clock signal periods.

29. The method of claim 26, further comprising:
adjusting a frequency of a horizontal synchronization signal of the video signal in proportion with the frequency of the pixel clock signal.

30. The method of claim 25, further comprising:
adjusting the frequency of the pixel clock signal so that the number of periods of the pixel clock signal correspond with the predetermined number of pixel clock signal periods when the blanking range starts; and
readjusting the frequency of the pixel clock signal to the initial frequency when the blank range finishes.

31. The method of claim 30, further comprising:
bypassing the frequency adjustor without adjusting the frequency of the pixel clock signal thereof when the number of periods of the pixel clock signal is the same as the predetermined number of pixel clock signal periods.

32. The method of claim 25, further comprising:
adjusting a frequency of a horizontal synchronization signal of the video signal in proportion with the frequency of the pixel clock signal.
